(19) United States
(12) Patent Application Publication
(10) Pub. No.: US 2026/0148502 A1
(43) Pub. Date: May 28, 2026

(54) CHANGING A VIEW WITHIN A VIRTUAL THREE-DIMENSIONAL ENVIRONMENT

(71) Applicant: Telefonaktiebolaget LM Ericsson (publ), Stockholm (SE)

(72) Inventors: Elijs DIMA, Upplands Väsby (SE); Manish SONAL, Sollentuna (SE)

(21) Appl. No.: 18/873,883

(22) PCT Filed: Jun. 15, 2022
(86) PCT No.: PCT/EP2022/066363

§ 371 Date: Dec. 11, 2024

(51) Int. Cl. G06T 19/00; G06F 3/04845

(52) U.S. Cl. CPC G06T 19/003; G06F 3/04845; G06F 2203/04806

(57) ABSTRACT

A method (1000) of changing a view within a virtual three-dimensional, 3D, environment is provided. The method comprises obtaining (s1002) a current view of the virtual 3D environment, where the current view is with respect to the first location, and obtaining (s1004) an indication of a user's action for changing a view within the virtual 3D environment, where the changed view is associated with a directional vector. The method further comprises identifying (s1006) a 3D virtual point corresponding to the directional vector and the distance from the first location to a real point associated to the 3D virtual point. The method further comprises based on the first location, a second location different from the first location and the distance determining (s1008) how to update the current view. Updating the current view is either enlarging a portion of the current view or changing to another view that is with respect to the second location.

### TECHNICAL FIELD

Disclosed are embodiments related to methods and apparatus for changing a view within a virtual three-dimensional (3D) environment.

### BACKGROUND

Improvement of visual sensors such as Light Detection and Ranging (LiDAR) sensors and 3D cameras have brought 3D visualization and its applications close to consumers. Many industrial applications in the field of construction, factory, retail, 3D photography, travel, and hospitality rely on accurate 3D digital twin models. Matterport (“Matterport,” Mar. 22, 2022. [Online]. Available: https://matterport.com/3d-capture-applications) is one of companies, which sells commercial software and hardware enabling 3D capture and visualization. When it comes to digital twin technologies, performing correct 3D data acquisition and visualizing the captured 3D scene in a user friendly and intuitive way are important.

Typically, a user can look around a virtual 3D environment from certain fixed locations within the virtual 3D environment with a full freedom of viewing direction, and navigate (i.e., switch) to different viewing locations within the 3D environment.

### SUMMARY

However, there are problems with existing solutions such as Matterport viewer (e.g., described in U.S. Pat. No. 10,655,969 B2) for 360° viewing of a virtual 3D environment. One of the problems is that, in the existing solutions, users are allowed to switch from location to location without considering environment objects such as walls. Such switching can make navigation from location to location in the virtual 3D environment confusing and unnatural.

Another problem is that, in existing solutions, a user may end up moving back-and-forth between the same few suboptimal locations when there is no better target location to move to, thereby making it more difficult for the user to examine some parts of the environment more thoroughly and closely. Also, existing solutions do not provide a clear indication to the user that there is no better location along the direction the user is looking at.

Furthermore, existing solutions often rely on visual depiction of other view locations inside the current view, which may inevitably obstruct parts of the rendered environment in the current view and clutter the existing view, thereby potentially making it more difficult for the user to examine some parts of the environment or keep a sense of “being there” (immersion).

Some existing solutions (e.g., such as the one described in U.S. Pat. No. 10,655,969 B2) also require the virtual 3D environment to be virtually loaded using a textured, detailed 3D mesh in order to allow the user to navigate through the virtual 3D environment, thereby increasing the computational complexity of rendering and possibly causing visible distortions in the original 360° capture.

Therefore, there is a need for methods and/or apparatus for correcting the above described problems of arbitrary movement and of suboptimal locations.

Accordingly, in one aspect of the embodiments of this disclosure, there is provided a method of changing a view within a virtual three-dimensional, 3D, environment generated using a plurality of images each of which shows a 360-degree view of a real environment at different locations within the real environment. The plurality of images includes a first image captured at a first location within the real environment and a second image captured at a second location within the real environment. The method comprises obtaining a current view of the virtual 3D environment, wherein the current view is with respect to the first location, and obtaining an indication of a user's action for changing a view within the virtual 3D environment, wherein the changed view is associated with a directional vector. The method further comprises identifying a 3D virtual point corresponding to the directional vector, wherein the 3D virtual point is associated with a first distance value indicating a distance between the first location and a real physical point corresponding to the 3D virtual point. The method further comprises based on the first location, the second location, and the first distance value, determining how to update the current view, wherein updating the current view is either enlarging a portion of the current view or changing to another view that is with respect to the second location.

In another aspect, there is provided a computer program comprising instructions which when executed by processing circuitry cause the processing circuitry to perform the method of any one of the embodiments described above.

In a different aspect, there is provided an apparatus for changing a view within a virtual three-dimensional, 3D, environment generated using a plurality of images each of which shows a 360-degree view of a real environment at different locations within the real environment. The plurality of images includes a first image captured at a first location within the real environment and a second image captured at a second location within the real environment. The apparatus is configured to obtain a current view of the virtual 3D environment, wherein the current view is with respect to the first location, and obtain an indication of a user's action for changing a view within the virtual 3D environment, wherein the changed view is associated with a directional vector. The apparatus is further configured to identify a 3D virtual point corresponding to the directional vector, wherein the 3D virtual point is associated with a first distance value indicating a distance between the first location and a real physical point corresponding to the 3D virtual point. The apparatus is further configured to, based on the first location, the second location, and the first distance value, determine how to update the current view, wherein updating the current view is either enlarging a portion of the current view or changing to another view that is with respect to the second location.

In a different aspect, there is provided an apparatus. The apparatus comprises a processing circuitry, and a memory, said memory containing instructions executable by said processing circuitry, whereby the apparatus is operative to perform the method of any one of the embodiments described above.

The embodiments of this disclosure correct the problem of arbitrary movement from location to location by introducing distance and obstructor awareness for multiple-location 360° scenes. This renders the transitions from location to location more consistent with the environment geometry, thereby leading to a more straightforward, easy to use navigation for immersive viewing of the virtual 3D environment with a set of fixed viewing-locations (i.e., 360-degree viewing).

For example, the embodiments enable users to more closely inspect intermediate features (such as walls) that lie between two existing locations, without incurring unwanted transitions to locations that are nominally behind the walls or other occluding objects.

The embodiments also correct the problem of suboptimal locations by employing smart alternation between view transitions from one location to another location and view enhancements (i.e., zooming) from a given location in the virtual scene. For example, some embodiments of this disclosure resolve ambiguity in user experience/interaction when the user needs to closely inspect some parts of a virtual 3D environment that does not have a clear optimal location, by performing the view zoom-in to allow closer inspection and to indicate to the user that no closer locations is available in the given viewing direction.

Furthermore, the embodiments of this disclosure allow keeping visual rendering to 360° images and simple virtual surfaces without projecting textures onto full 3D environment meshes, thereby keeping the apparent image resolution and accuracy of the environment as recorded by the 360° capture. The embodiments also allow navigation between different panoramic (360°) views without the need for any visualization of other views or their locations, while still giving sufficient interaction feedback to the user. By skipping the process of projecting textures and visualizing other views or locations, the virtual 3D environment can be rendered faster with less processing.

The accompanying drawings, which are incorporated herein and form part of the specification, illustrate various embodiments.

### BRIEF DESCRIPTION OF THE DRAWINGS

FIGS. 1(a)-1(e) illustrate the problems of existing techniques for changing a view in a virtual 3D environment.

FIG. 2 shows a process of changing a view in a virtual 3D environment according to some embodiments.

FIG. 3 shows a scene captured by 360-degree camera(s).

FIG. 4 shows an example of an equirectangular 360-degree image.

FIG. 5 shows an example of a cubemap 360-degree image.

FIG. 6 shows a plurality of sectors for a current viewing location and one or more viewing locations mapped to each of the plurality of sectors.

FIGS. 7(a) and 7(b) show a user's views towards the same sector of the virtual 3D environment.

FIG. 8 shows a first distance between a current viewing location and the best available viewing location in a particular sector and a second distance between the current viewing location and a real-world point located between the current viewing location and the best available viewing location.

FIG. 9 illustrates a method of comparing the aforementioned first distance and the aforementioned second distance.

FIG. shows a process of changing a view in a virtual 3D environment according to some embodiments.

FIG. 11 shows an apparatus according to some embodiments.

### DETAILED DESCRIPTION

Conventionally, in order to generate 360-degree views of a virtual 3D environment, one or more cameras are placed at different locations in a real-world environment and are used to capture a 360-degree view of the real-world environment at each location. As an example, in case the virtual 3D environment is a reconstruction of the interior of a house, one 360-degree view may be obtained at a location in the kitchen and another 360-degree view may be obtained at a location in the living room. While navigating within the virtual 3D environment, a user's view is moved from one location at which one 360-degree view is obtained (e.g., the location in the kitchen) to another location at which another 360-degree view is obtained (e.g., the location in the living room).

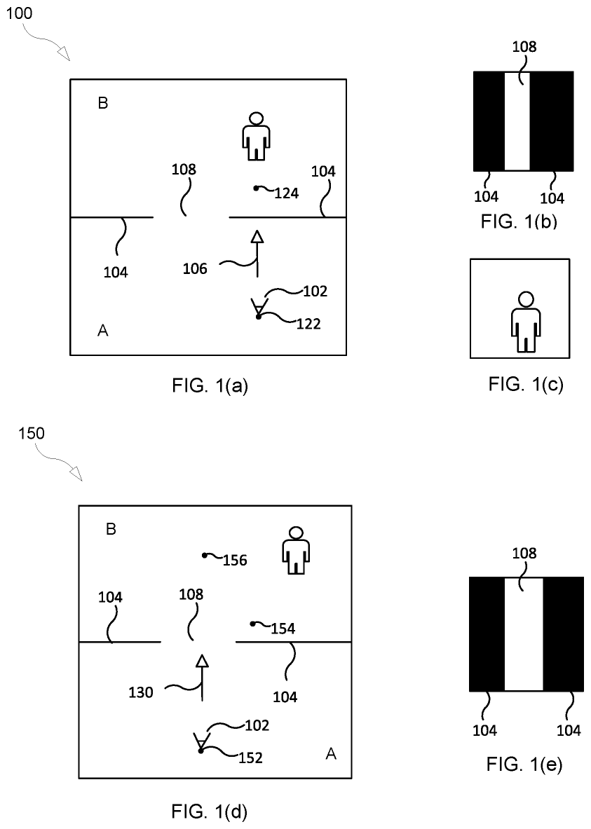

FIGS. 1(a)-1(c) illustrate a problem of existing techniques for changing a view in a virtual 3D environment. In a virtual 3D environment 100 shown in FIG. 1(a), a virtual user (a.k.a., “viewer”) 102 located at location 122 in space A is looking towards space B in a direction 106. FIG. 1(b) shows a portion of user 102's view towards space B. As shown in FIGS. 1(a) and 1(b), space A and space B are separated by wall 104 including an opening 108.

In response to an actuation of a user input device (e.g., clicking a button on a mouse, pressing a key in a keyboard, or touching a graphical user interface on a touch screen), user 102's view can be changed from a view at location 122 to a view at another location (e.g., location 124). Here, each of location 122 and location 124 corresponds to a real-world location at which a 360-degree image was captured. However, it is not natural to directly change user 102's view from a view at location 122 to a view at location 124 as there is wall 104 separating space A and space B. More specifically, it is not natural to directly change user 102's view from the view shown in FIG. 1(b) to view shown in FIG. 1(c) as such direct change of the view would provide the impression as if user 102 goes through wall 104.

FIGS. 1(d) and 1(e) illustrate another problem of existing techniques for changing a view in a virtual 3D environment. In a virtual 3D environment 150 shown in FIG. 1(d), user 102 located at location 152 in space A is looking towards space B in a direction 158. FIG. 1(e) shows a portion of user 102's view towards space B.

In response to an actuation of a user input device (e.g., clicking a button on a mouse, pressing a key in a keyboard, or touching a graphical user interface on a touch screen), user 102's view can be changed from a view at location 152 to a view at a location 154 instead of a location 156 as location 152 is closer to location 154 than location 156. However, it is not natural to change user 102's view from a view at location 152 to a view at location 154 as the direction of the change of user 102's view (i.e., location 152 to location 154) is not consistent with the direction of user 102's current view (i.e., a direction 130).

Accordingly, in some embodiments of this disclosure, a process 200 is used for changing user 102's view in a virtual 3D environment. Process 200 may begin with step s202. Step s202 comprises capturing a real-world environment using one or more cameras at different locations, thereby generating a plurality of 360-degree images.

FIG. 3 shows one possible method of capturing a real-world environment using one or more 360-degree camera (herein after, “camera”) (e.g., Leica BLK360 LiDAR scan). The specific layout and the locationing of the 6 sides shown in FIG. 3 are provided for illustration purpose only, and do not limit the embodiments of this disclosure in any way.

In this disclosure, 360-degree camera is any camera that is capable of capturing a 360-degree view of a real-world environment. The camera may be a single unit or may comprise a plurality of units.

The camera may be placed at different locations (c1, c2, c3, c4, c5, and c6) in the real-world environment. At each location (c1, c2, c3, c4, c5, or c6), the camera captures visual data of its surroundings as a 360-degree image (in some cases, the 360-degree image may be split into several parts in a storage).

During the capturing process, additional information such as the location of the camera in a world coordinate system (e.g., as an (x, y, z) coordinates), pose(s) of the captured image(s) (e.g., a direction of the captured image), and distances from the camera to scene points and objects may be obtained. This additional information can be generated by the camera or can be estimated at the end of the capturing process. The capturing process may be repeated for all predetermined locations (e.g., c1, c2, c3, c4, c5, or c6).

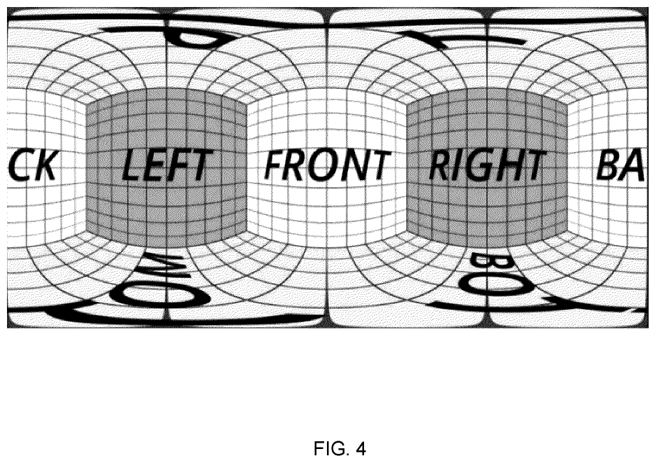

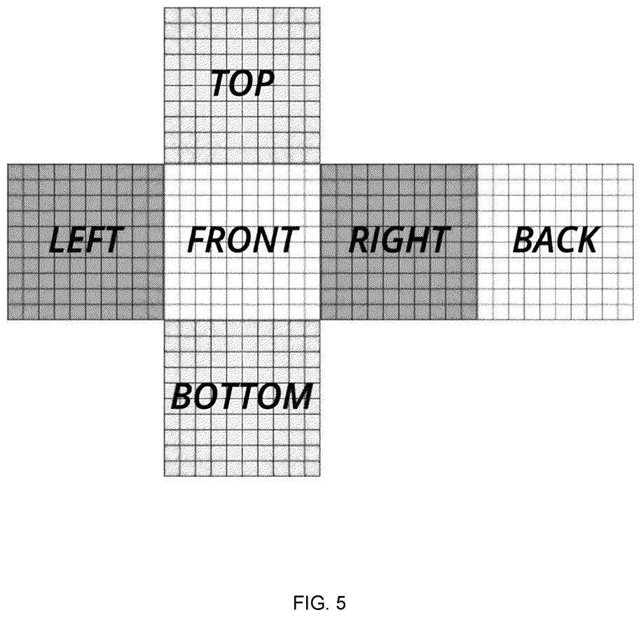

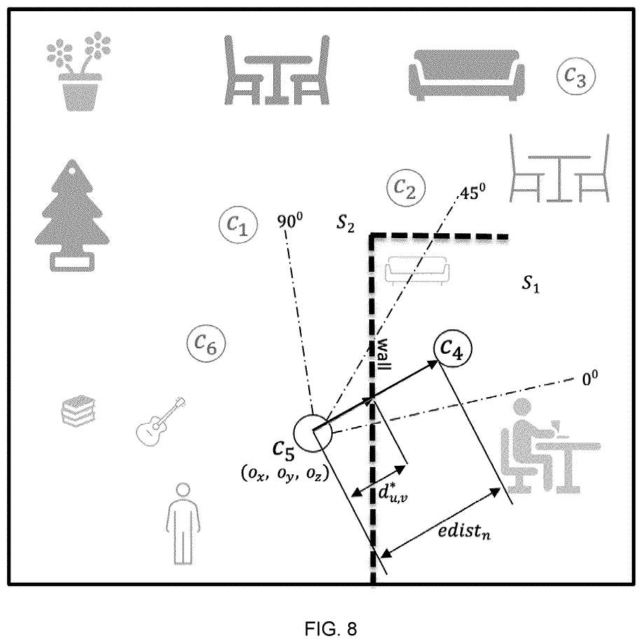

Step s204 comprises projecting the captured 360-degree images onto a simple 3D surface that virtually encloses user 102. More specifically, for each location at which each 360-degree image was captured, the visual data generated in step s202 can be mapped to different geometrical surfaces and visualized using software (e.g., off-the-shelf software such as Matterport viewer or WebGL based libraries like ThreeJS). Typical mappings may involve (but are not required to involve) taking an equirectangular image (such as the one shown in FIG. 4) and mapping it to a virtual sphere enclosing user 102 or taking a 6-part cubemap image and mapping it to a virtual cube. FIG. 5 shows an example of a cubemap 360-degree image and FIG. 8 shows an example of a virtual cube 802. As shown in FIG. 8, each portion of the cubemap image is mapped to a different side of virtual cube 802.

A virtual camera may then be placed inside the virtual sphere or cube in order to produce (i.e., render) user 102's view. Such rendering allows user 102 to view the captured 3D environment in a full freedom of viewing direction from a fixed location, thereby allowing for immersive (as if “being there”) viewing.

Step s206 comprises mapping the scene geometry (as per-pixel depth, or as point clouds) of the captured 3D environment to the captured 360-degree images obtained in step s202. In some embodiments, commercially available LiDAR-based 360 cameras (e.g., Leica BLK360) may be used to measure the 3D geometry of the real-world environment directly during the capturing process.

The measured 3D geometry can be provided as a depth map or a depth channel, which directly maps each pixel of the captured 360-degree images to a corresponding distance-from-camera value. For example, a pixel 852 included in the captured 360-degree image may be mapped to a depth value, which indicates a distance between the location of the camera used for capturing the 360-degree image and a real-world point that was captured by the camera and that corresponds to pixel 852.

Depth channel is an additional data layer on a 360 degree image. In images, there are typically 3 channels for colors of pixels (e.g., RGB). In RGBD images, there are four channels (R, G, B, depth). The depth channel does not indicate the color of a pixel. It indicates a distance between a point corresponding to the pixel with respect to a reference point.

This is exactly like an RGB+Depthmap image pair, but this is just stored in one image instead of a color Image+depth map. Sometimes, the depth channel is also called a “depth map” even when it's a part of a 4-channel RGBD image.

Alternatively, the measured 3D geometry can be provided as a point cloud-a collection of points with at least the 3D location information for each point. These 3D points can be down-projected onto the captured visual image(s). The down-projection can be performed by using commercial LiDAR sensors as part of their API (e.g., the Ouster LiDAR sensors), or can be performed using projective view geometry models and publicly available computer vision libraries such as OpenCV.

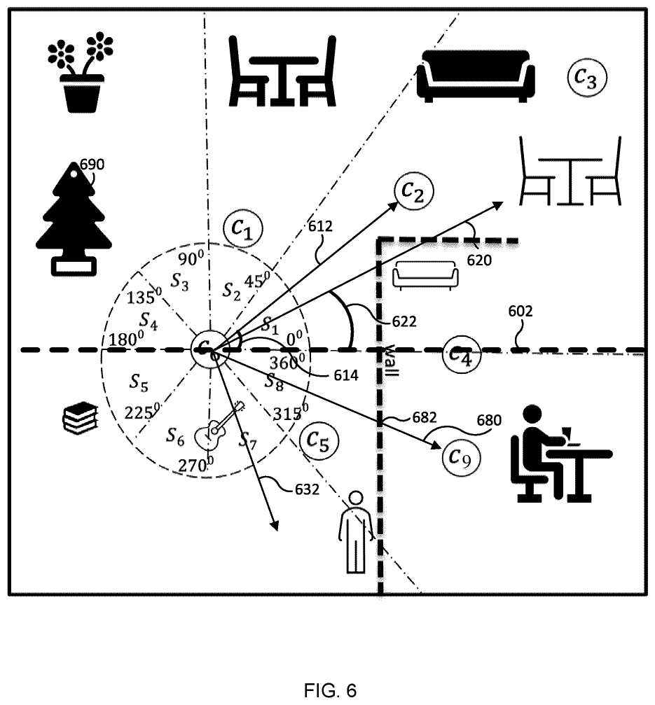

Step s208 comprises determining a list of best available viewing locations to switch to from each of a plurality of viewing locations (e.g., c1, c2, . . . , c6 shown in FIG. 6). In this disclosure, an available viewing location is a location at which a 360-degree image of the real-environment was captured. As discussed above, since a plurality of 360-degree images of the real-environment is captured in step s202, in step s208, some of the locations at which the plurality of 360-degree images was captured are selected and identified to be the best locations to switch to from a particular location.

For example, let's assume that the current view of user 102 is at the sixth location c6 in FIG. 6. At the current viewing location c6, user 102 should be able to move through the virtual 3D environment in an intuitive and natural way. Here, moving means switching user 102's view from a view at one available viewing location (e.g., c6) to another available viewing location (e.g., c5).

In order to switch user 102's view in an intuitive and natural way, in some embodiments, a list of best available viewing locations may be determined for the current viewing location. The paragraphs below explain a method of determining the list of best available viewing locations.

Imagine a circle having an infinite radius around each available viewing location (a.k.a., each “camera location” or “node”). Each of these circles may be divided into a specified number of sectors Nₛ. Nₛ may be a fixed number (e.g., 3, 8, or 10) or it can be estimated using environment information like density of nodes in a particular region in the 3D environment. Each sector may have the same size or may have different sizes, and may correspond to a particular range of angle around each circle.

For example, in FIG. 6, the circle corresponding to the current viewing location c6 may be divided into eight equal sectors (s1, s2, . . . , s8). Each of these sectors has a start angle and an end angle which define the sector's span. For example, the first sector s1 has the start angle of 0 degree and the end angle of 45 degree. Similarly, the second sector s2 has the start angle of 45 degree and the end angle of 90 degree. The number of sectors and the span of each sector are provided in FIG. 6 for illustration purpose only and do not limit the embodiments of this disclosure in any way.

Then, for each sector, viewing locations (i.e., nodes) that fall within the sector are identified. Then, among the different identified viewing locations that fall within the same sector, the viewing location that is closest to (e.g., based on Euclidian distance) the current viewing location (e.g., c6) is identified. This identified node is the best next available viewing location of the sector for the current viewing location.

One way to determine the sector a particular viewing location belongs to is using polar coordinates. Here, polar coordinates mean angular coordinates from a node center, i.e., the current viewing location c6. Each sector may be associated with a particular range of angle.

For example, in FIG. 6, the first sector S1 is associated with a range of angle from 0 to 45 degrees, the second sector S2 is associated with a range of angle from 45 to 90 degrees, the third sector S3 is associated with a range of angle from 90 to 135 degrees, etc.

Then once an angle (e.g., 30 degrees) formed by a directional vector (e.g., 612) from the current viewing location (e.g., c6) to a particular viewing location (e.g., c2) with a respect to a reference line (e.g., 602) is determined, the sector (e.g., S1) having the range of angle (between 0 and 45 degrees) in which the angle (e.g., 30 degrees) is included is the sector that is associated with the particular viewing location (e.g., c2).

In order to determine the angle (e.g., 614 in FIG. 6) formed by the directional vector (e.g., 612) from the current viewing location (e.g., c6) to any other viewing location cn (e.g., c2), the coordinate of each viewing location (e.g., c1, c2, . . . , c6) in the world coordinate system can be used. Note that the coordinate of each viewing location corresponds the coordinate of each location at which one of the 360-degree images was captured, and is already obtained in step s202.

In some embodiments, the angle formed by the directional vector from the current viewing location to a particular viewing location can be estimated as:

$$angle = {tan}^{- 1} \frac{( {c}_{6} y - {c}_{n} y )}{( {c}_{6} x - {c}_{n} x )}$$

where the coordinate of the current viewing location is (c6x, c6y, c6z) and the coordinate of the particular viewing location is (cnx, cny, cnz). Note that none of the z-coordinates of the current viewing location and the particular viewing location is used for determining the angle because the current viewing location and the particular viewing location are assumed to be on the same plane.

Once the angle formed by the directional vector from the current viewing location to a particular viewing location (a.k.a., “node angle”) is determined, the next step is identifying a sector to which the particular viewing location is belong. One way to find a sector to which the particular viewing location belong is by determining whether the node angle is within a range of angle associated with one of those sectors.

For example, if the node angle of a particular viewing location (e.g., c2) is greater than the start angle of a particular sector (e.g., 0 degree for the first sector s1) but less than the end angle of the particular sector (e.g., 45 degree), then the particular viewing location (e.g., c2) is within the particular sector (e.g., S1).

There may be a scenario where a plurality of viewing locations is within a particular sector. For example, in FIG. 6, the second viewing location C2 and the third viewing location C3 are within the second sector s2. In such scenario, one of the plurality of viewing locations within the same sector may be selected as the best viewing location for the particular sector with respect to the current viewing location.

In order to select the best viewing location from the plurality of viewing locations in the same sector, in some embodiments, the Euclidean distance (edist) between the current viewing location and each of the plurality of viewing locations in the same sector can be estimated. In one example,

$${edist}_{n} = \sqrt{{( {c}_{6} x - {c}_{n} x )}^{2} + {( {c}_{6} y - {c}_{n} y )}^{2}}$$

After estimating the distances from the current viewing location for all of the plurality of viewing locations in the same sector, the viewing location which is closest to the current viewing location may be selected as the best viewing location for the particular sector. For example, in FIG. 6, the viewing locations c2 and c3 are within the sector S1. But since the current viewing location c6 is closer to the viewing location c2 than the viewing location c3, the viewing location c2 is selected as the best viewing location for the sector S1 for the current viewing location c6. The current viewing location's final mapping information indicating the best viewing location for each sector may look like:

$$\{ {c}_{6} : [ \{ {S}_{1} , {c}_{2} \} , \{ {S}_{2} , {c}_{1} \} , \{ {S}_{3} , NULL \} , \{ {S}_{4} , NULL \} , \{ {S}_{5} , NULL \} , \{ {S}_{6} , NULL \} , \{ {S}_{7} , NULL \} , \{ {S}_{8} , {C}_{5} \} ] \} ,$$

where NULL means there is no available viewing location in the given sector.

The above steps for determining the best available viewing location for each sector can be repeated for each of the available viewing locations (c1, c2, . . . , c6) to build the map corresponding to each of the viewing locations.

The best viewing location for each sector, which is determined in step s208 may be used for changing user 102's view in the virtual 3D environment in a natural way.

When user 102 is viewing the virtual 3D environment from a certain location (e.g., c6) the presented view is typically a portion of the whole 360-degree environment, associated with a certain viewing direction.

As discussed above, the viewing direction can be controlled by a user by actuating an input device (e.g., pressing a button of a mouse, pressing a key of a keyboard, or touching a graphical user interface of a touch screen, etc.). This viewing direction can be tracked as a 3D vector (e.g., [px, py, pz]) in the virtual 3D environment. This viewing direction can be the “current” direction of the virtual camera, or the direction to some point the user indicates.

When an indication to change the current viewing direction of user 102 (e.g., detecting that a user pressed a mouse button) is obtained, the projection of the viewing direction in the virtual horizontal plane (e.g., as [px, py]) may be obtained, and the viewing angle corresponding to the viewing direction can be found as follows:

$$angleView = {tan}^{- 1} \frac{{p}_{y}}{{p}_{x}}$$

Once the current viewing angle is obtained, a sector user 102 is facing may be identified, and based on the identified sector, the next viewing location to switch to from the current viewing location is determined.

For example, in FIG. 6, in case the current viewing location is c6 and the current viewing direction is 620, the current viewing angle 622 of the current viewing direction 620 is obtained. Here, the current viewing angle 622 of the current viewing direction 620 is 22 degree.

Once the current viewing angle 622 is obtained, it is determined as to whether the current viewing angle 622 is within any range of angles associated with any of the sectors. In the example above, since the current viewing angle 622 is 22 degree and 22 degree is within a range of angle between 0 and 45 degrees, the sector that user 102 is facing is the first sector S1. Once the sector user 102 is facing is determined, the best available viewing location in the determined sector is set as the next viewing location user 102's view to switch to from the current viewing location. Thus, in the example above, the second viewing location C2 which is the best available viewing location in the first sector S1 is set as the new viewing location.

Once the next viewing location is determined, user 102's view is switched from the current viewing location (e.g., c6) to the next viewing location (e.g., c2), thereby completing the switching process. In some embodiments, in order to maintain the immersion consistency, the current viewing angle—i.e., the angleView—is maintained through the transition, regardless of whether the virtual camera and virtual projection surface are relocated or not.

In some scenarios, switching directly from one viewing location to another viewing location may not be desirable. For example, in FIG. 6, switching directly from the fifth viewing location c5 to the fourth viewing location c4 is not desirable because such switching would give the impression of moving through the wall of the virtual 3D environment (Note that there is the wall between the fifth viewing location c5 and the fourth viewing location c4). This viewing switching is not desirable especially if, for example, user 102 merely wants to change user 102's view such that user 102's view is closer to the wall.

Also, there may be a scenario where it is initiated to change user 102's view towards a particular sector but there is no available viewing location in the particular sector. For example, in the virtual 3D environment shown in FIG. 6, if it is initiated to change user 102's view (e.g., by pressing a mouse button or touching a touch screen) currently at the location c6 towards the sector S7, it may not be desirable to change user 102's view from the location c6 to any other available viewing location because none of the available viewing locations is in the sector S7. In such scenario, user 102 may just want to view closer to what user 102 sees in the direction of the sector S7.

In order to solve the above described problems, in some embodiments, one of (1) the operation of changing the current view at the current view location to another view at another viewing location and (2) the operation of zooming the current view is selectively performed. The method of selectively performing the operation (1) or (2) can be summarized as follows.

Upon detecting a triggering event (e.g., pressing a mouse button) that triggers switching user 102's view from the current view (e.g., c6) to another view (e.g., c9) in a particular direction (e.g., 680), a determination may be made as to whether there is any available viewing locations in the sector (e.g., S8) corresponding to the particular direction (e.g., 680). If there is no available viewing location in the sector corresponding to the particular direction, the zooming operation is performed.

On the other hand, if there is any available viewing location (e.g., c9) in the particular sector, a determination is made as to whether to perform the operation (1) or the operation (2). The determination may be based on a comparison of a first distance between the current viewing location (e.g., c6) and the available viewing location (e.g., c9) and a second distance between the current viewing location (e.g., c6) and a real-world point 682 (e.g., a point in the wall). If the first distance is greater than the second distance, it may indicate that there is an object (e.g., the wall) between the current viewing location (e.g., c6) and the available viewing location (e.g., c9). In such case, the operation (2) (i.e., the zooming operation) is performed. On the other hand, if the first distance is less than the second distance, it may indicate that there is no object between the current viewing location and the available viewing location. In such case, the operation (1) (i.e., switching the current view to the view at C9) may be performed.

Detailed explanation regarding the selection of the operation (1) and the operation (2) is described below.

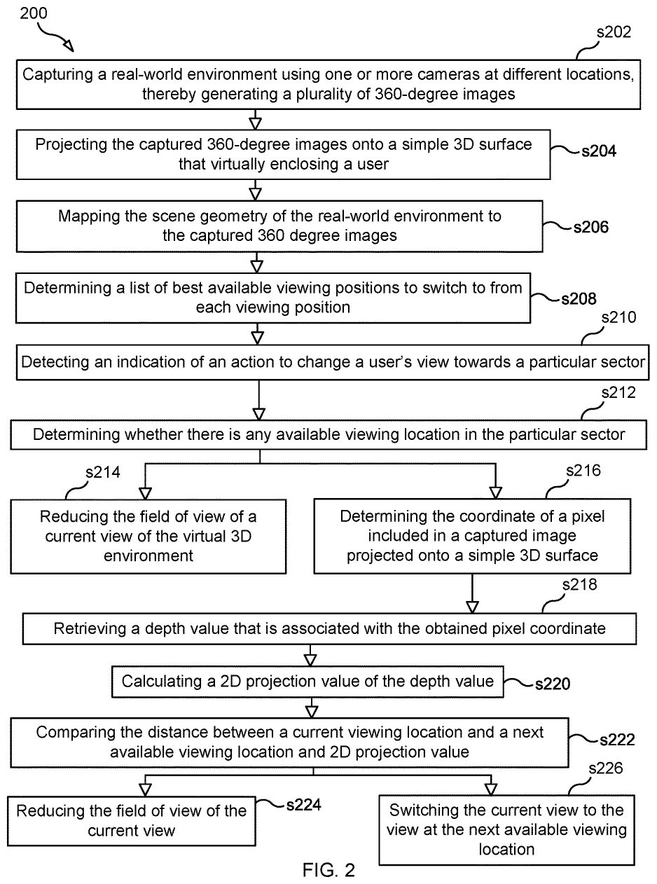

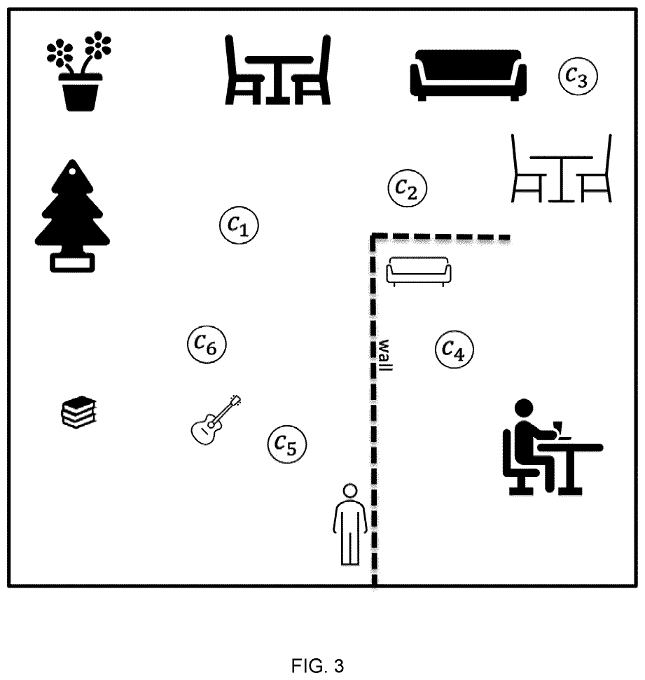

Referring back to FIG. 2, process 200 may further comprise step s210. Step s210 comprises detecting an indication of an action to change user 102's view towards a particular sector. Examples of the action to change user 102's view include pressing a button on a mouse, pressing a key included in a keyboard, touching a touch panel or screen, etc.

After detecting the indication of the action to change user 102's view, step s212 may be performed. Step s212 comprises determining whether there is any available viewing location in the particular sector identified in step s210. In case there is no available viewing location in the particular sector, process 200 may proceed to step s214.

Step s214 comprises reducing the field-of-view (“FoV”) of the virtual 3D environment by some extent (e.g., one half), which corresponds to zooming-in the current view (e.g., doubling). In some embodiments, during the zooming operation, the viewing direction and the viewing location may be maintained.

For example, let's assume that user 102's current view location is the location c6 (shown in FIG. 6) and there is an indication that user 102 wants to change user 102's view from the current viewing location c6 towards the seventh sector S7 (e.g., in the direction 632). In this scenario, because there is no available viewing location in the seventh sector S7, in step s214, user 102's FoV towards the sector S7 would be reduced by some extent, thereby resulting in zooming-in user 102's current view in the direction 632.

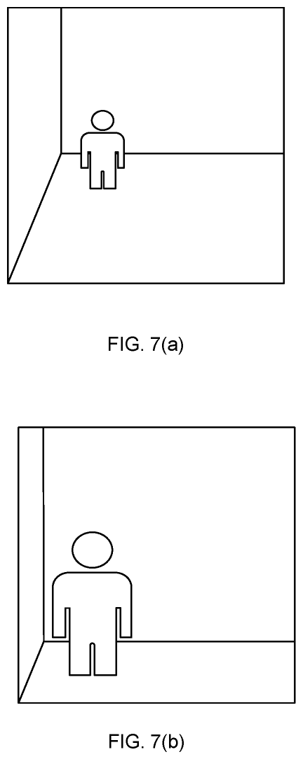

FIG. 7(a) shows user 102's view before performing step s214 and FIG. 7(b) shows user 102's view after performing step s214. As shown in the figures, during the zooming operation, the viewing direction can be maintained. In some embodiments, step s214 may be performed repeatedly until user 102's FoV reaches a predefined minimum FoV. Once user 102's FOV reaches the predefined minimum FoV, in some embodiments, user 102's FoV may cycle back to the initial FoV.

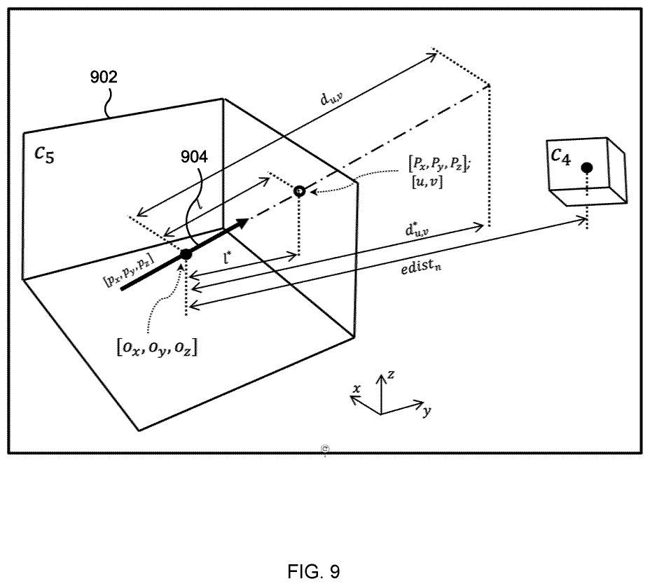

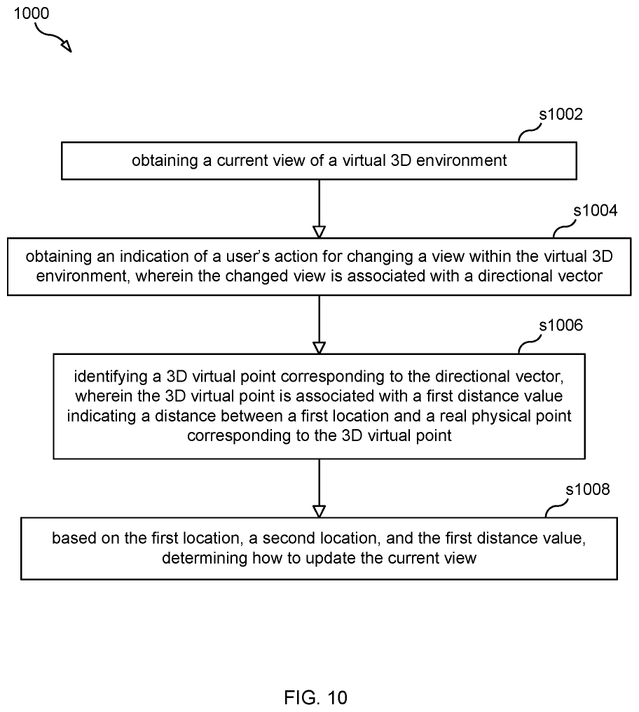

On the other hand, in step s212, if it is determined that there is available viewing location in the particular sector, then process 200 may proceed to step s216 instead of step s214. Step s216 comprises determining the coordinate of a pixel (a.k.a., “pixel coordinate”) included in the image projected onto a simple 3D surface in step s204. Note that the pixel coordinate is a two-dimensional coordinate defined on the plane of an image comprising a plurality of pixels. FIG. 9 shows an example of the image (e.g., such as the one shown in FIG. 5) projected on a 3D cube 902 that virtually encloses user 102 (located at the coordinate [Ox, Oy, Oz]).

The pixel coordinate ([u,v]) can be obtained by casting a ray from the current viewing location (i.e., the current virtual camera origin) ([oₓ, o_{y}, o_{z}]) in the direction of the directional vector 904 ([pₓ, p_{y}, p_{z}]) towards the 3D cube 902. Then, there will be an intersection point where the ray intersects one of the surfaces of 3D cube 902. The intersection point is the pixel coordinate ([u,v]) in a two-dimensional coordinate system defining the image plane. The intersection point may also correspond to a 3D point ([Pₓ, P_{y}, P_{z}]) in a 3D coordinate system of a virtual 3D environment. In some embodiments, the raycast function that is commonly available in most OpenGL and WebGL based 3D rendering libraries (such as ThreeJS) can be used to determine the intersection point (thereby determining the pixel coordinate and the coordinate of the 3D point (“3D coordinate”)).

Once the pixel coordinate and the 3D coordinate are obtained in step s216, process 200 may proceed to step s218. Step s218 comprises retrieving from the depth map or the point cloud obtained in step s206 a depth value d_{u,v} that is associated with the obtained pixel coordinate. The depth value d_{u,v} is a direct depth value for the pixel at the pixel coordinate [u, v], or an average of a plurality of depth values obtained from the region around the pixel coordinate [u, v]. The depth value may indicate an actual physical distance between the current viewing location and a real-world point corresponding to the pixel coordinate. As an example, in case the current viewing location is c6, the depth value for the pixel corresponding to the tip of tree 690 may indicate an actual physical distance between the tip of tree 690 and the location c6.

As discussed above, in order to determine whether to zoom-in the current view or to switch the current view to another view at another available viewing location, there may be a need for comparing a distance from the current viewing location to the real-world location corresponding to the 3D point and a distance from the current viewing location to the best available viewing location in the particular sector.

However, as explained above and as shown in FIGS. 8 and 9, the distance (edistₙ) between the current viewing location and the next available viewing location is a 2D distance (i.e., the distance that is calculated based on 2D coordinates) while the distance (d_{u,v}) between the current viewing location and the real-world location is a 3D distance (i.e., the distance that is calculated based on 3D coordinates).

Therefore, in step s220, the 2D projection value (a.k.a., the horizontal distance d*_{u,v}) of the 3D distance d_{u,v} is calculated. One way to calculate the horizontal distance d*_{u,v} is using the ratio of the 3D distance (l) between the current viewing location and the 3D point and the 2D distance (l*) between the current viewing location and the 3D point.

More specifically, if the coordinate of the current viewing location (i.e., the virtual camera location in the virtual space) is [oₓ, o_{y}, o_{z}] and the coordinate of the 3D point is [Pₓ, P_{y}, P_{z}], then the 3D distance between the current viewing location and the 3D point may be calculated as:

$$l = \sqrt{{( {P}_{x} - {o}_{x} )}^{2} + {( {P}_{y} - {o}_{y} )}^{2} + {( {P}_{z} - {o}_{z} )}^{2}}$$

Then, the 2D distance between the current viewing location and the 3D point may be calculated as:

$${l}^{*} = \sqrt{{( {P}_{x} - {o}_{x} )}^{2} + {( {P}_{y} - {o}_{y} )}^{2}}$$

Using the ratio of l and l*, the 2D projection value of the 3D distance d_{u,v} can be obtained as:

$${d}_{u , v}^{*} = {d}_{u , v} \times \frac{{l}^{*}}{l}$$

Once the 2D projection value is obtained, process 200 may proceed to step s222. Step s222 comprises comparing the distance (edistₙ) between the current viewing location and the next available viewing location and the distance (d*_{u,v}) between the current viewing location and the real-world location corresponding to the 3D point.

If d*_{u,v}>edistₙ, then process 200 may proceed to step s224 in which the current view is switched to the view at the next available viewing location.

On the other hand, if d*_{u,v}≤edistₙ, then process 200 may proceed to step s226 in which the FoV of the current view is reduced as described above without switching the view to the view at another viewing location.

FIG. 10 shows a process 1000 for changing a view within a virtual three-dimensional, 3D, environment generated using a plurality of images each of which shows a 360-degree view of a real environment at different locations within the real environment. The plurality of images includes a first image captured at a first location within the real environment and a second image captured at a second location within the real environment. Process 1000 may begin with step s1002. Step s1002 comprises obtaining a current view of the virtual 3D environment, wherein the current view is with respect to the first location. Step s1004 comprises obtaining an indication of a user's action for changing a view within the virtual 3D environment, wherein the changed view is associated with a directional vector. Step s1006 comprises identifying a 3D virtual point corresponding to the directional vector, wherein the 3D virtual point is associated with a first distance value indicating a distance between the first location and a real physical point corresponding to the 3D virtual point. Step s1008 comprises based on the first location, the second location, and the first distance value, determining how to update the current view, wherein updating the current view is either enlarging a portion of the current view or changing to another view that is with respect to the second location.

In some embodiments, the 360-degree view shown in the first image is divided into a plurality of sectors, and each of the plurality of sectors is assigned with a range of angle. Determining how to update the current view comprises: identifying from the ranges of angle a first range of angle in which an angle formed by the directional vector is included; and determining if any of the different locations belongs to the sector assigned with the identified first range of angle.

In some embodiments, determining how to update the current view comprises: determining that none of the different locations belongs to the sector assigned with the identified first range of angle; and as a result of determining that none of the different locations belongs to the sector assigned with the identified first range of angle, updating the current view by enlarging a portion of the current view.

In some embodiments, determining how to update the current view comprises: (i) determining that the second location belongs to the sector assigned with the identified first range of angle; (ii) determining that a transition condition is satisfied; and as a result of determining (i) and (ii), updating the current view by changing from the current view to said another view, wherein said another view with respect to the second location.

In some embodiments, the method further comprises generating a virtual geometry (e.g., a virtual sphere or a virtual cube) using the first image, wherein a center of the virtual geometry is a reference location, a direction of the directional vector is from the reference location towards a side of the virtual geometry, and the 3D virtual point is a point on the side of the virtual geometry, which corresponds to an intersection of the directional vector and the virtual geometry.

In some embodiments, the method further comprises determining a first length (e.g., 1) between a 3D coordinate of the reference location and a 3D coordinate of the 3D virtual point; determining a second length (e.g., 1*) between a 2D coordinate of the reference location and a 2D coordinate of the 3D virtual point; and determining how to update the current view based on the determined first length and the determined second length.

In some embodiments, the method further comprises calculating a second distance value (e.g., d_{u,v}*) based on the first distance value (e.g., d_{u,v}) and a ratio (e.g., 1*/1) of the first length and the second length.

In some embodiments, the second distance value is calculated based on the first distance value×(the second length/the first length).

In some embodiments, the method further comprises calculating a third distance value indicating a distance (e.g., e_{dist}) between the first location and the second location; and comparing the third distance value and the second distance value, wherein how to update the current view is determined based on the comparison.

In some embodiments, in case the second distance value is less than or equal to the third distance value, determining how to update the current value comprises determining to enlarge a portion of the current view.

In some embodiments, in case the second distance value is greater than the third distance value, determining how to update the current value comprises determining to switch from the current view to said another view.

In some embodiments, the 360-degree view shown in the first image is divided into a plurality of sectors each of which is assigned with a range of angle, the plurality of sectors includes a first sector assigned with a first range of angle, and the different locations include the second location and a third location, the second and third locations belong to the first sector. Determining how to update the current view comprises: identifying from the ranges of angle the first range of angle in which an angle formed by the directional vector is included; determining that the second and third locations belongs to the first sector; and selecting from the second and third locations the second location based on a comparison related to the second and third locations.

In some embodiments, the comparison related to the second and third locations is a comparison between a distance value indicating a distance between the first location and the second location and a distance value indicating a distance between the first location and the third location.

In some embodiments, the first image comprises a plurality of channels, the plurality of channels includes a depth channel indicating a plurality of depth values each of which is associated with each pixel included in the first image, and one of the depth values is the first distance value.

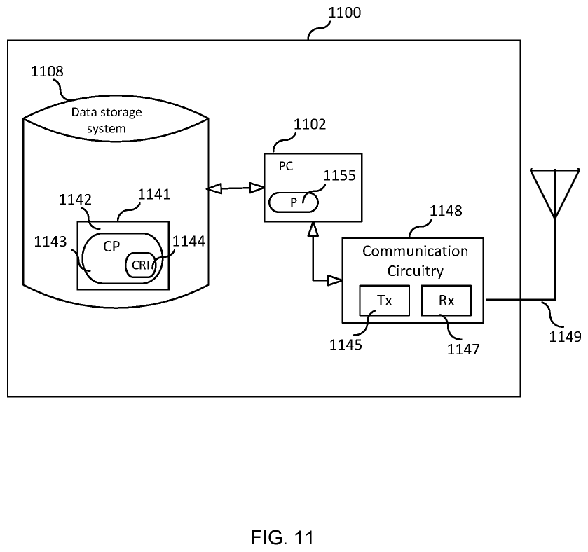

FIG. 11 shows an apparatus 1100 capable of performing all steps included in process 400 (shown in FIG. 4) or at least some of the steps included in process 400 (shown in FIG. 4). Apparatus 1100 may be any computing device. Examples of apparatus 1100 include but are not limited to a server, a laptop, a desktop, a tablet, a mobile phone, a smartphone etc. As shown in FIG. 11, the apparatus may comprise: processing circuitry (PC) 1102, which may include one or more processors (P) 1155 (e.g., one or more general purpose microprocessors and/or one or more other processors, such as an application specific integrated circuit (ASIC), field-programmable gate arrays (FPGAs), and the like); communication circuitry 1148, which is coupled to an antenna arrangement 1149 comprising one or more antennas and which comprises a transmitter (Tx) 1145 and a receiver (Rx) 1147 for enabling the apparatus to transmit data and receive data (e.g., wirelessly transmit/receive data); and a local storage unit (a.k.a., “data storage system”) 1108, which may include one or more non-volatile storage devices and/or one or more volatile storage devices. In some embodiments, the apparatus may not include the antenna arrangement 1149 but instead may include a connection arrangement needed for sending and/or receiving data using a wired connection. In embodiments where PC 1102 includes a programmable processor, a computer program product (CPP) 1141 may be provided. CPP 1141 includes a computer readable medium (CRM) 1142 storing a computer program (CP) 1143 comprising computer readable instructions (CRI) 1144. CRM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes the apparatus to perform steps described herein (e.g., steps described herein with reference to the flow charts). In other embodiments, the apparatus may be configured to perform steps described herein without the need for code. That is, for example, PC 1102 may consist merely of one or more ASICs. Hence, the features of the embodiments described herein may be implemented in hardware and/or software.

1. A method of changing a view within a virtual three-dimensional, (3D) environment generated using a plurality of images each of which shows a 360-degree view of a real environment at different locations within the real environment, wherein the plurality of images includes a first image captured at a first location within the real environment and a second image captured at a second location within the real environment, the method comprising:
obtaining a current view of the virtual 3D environment, wherein the current view is with respect to the first location;
obtaining an indication of a user's action for changing a view within the virtual 3D environment, wherein the changed view is associated with a directional vector;
identifying a 3D virtual point corresponding to the directional vector, wherein the 3D virtual point is associated with a first distance value indicating a distance between the first location and a real physical point corresponding to the 3D virtual point; and
based on the first location, the second location, and the first distance value, determining how to update the current view, wherein updating the current view is either enlarging a portion of the current view or changing to another view that is with respect to the second location.

2. The method of claim 1, wherein
the 360-degree view shown in the first image is divided into a plurality of sectors, each of the plurality of sectors is assigned a range of angle, and
determining how to update the current view comprises:
identifying from the ranges of angle a first range of angle in which an angle formed by the directional vector is included; and
determining if any of the different locations belongs to the sector assigned with the identified first range of angle.

3. The method of claim 2, wherein determining how to update the current view comprises:
determining that none of the different locations belongs to the sector assigned with the identified first range of angle; and
as a result of determining that none of the different locations belongs to the sector assigned with the identified first range of angle, updating the current view by enlarging a portion of the current view.

4. The method of claim 2, wherein determining how to update the current view comprises:
(i) determining that the second location belongs to the sector assigned with the identified first range of angle;
(ii) determining that a transition condition is satisfied; and
as a result of determining (i) and (ii), updating the current view by changing from the current view to said another view, wherein said another view with respect to the second location.

5. The method of claim 1, comprising:
generating a virtual geometry using the first image, wherein
a center of the virtual geometry is a reference location,
a direction of the directional vector is from the reference location towards a side of the virtual geometry, and
the 3D virtual point is a point on the side of the virtual geometry, which corresponds to an intersection of the directional vector and the virtual geometry.

6. The method of claim 5, comprising:
determining a first length between a 3D coordinate of the reference location and a 3D coordinate of the 3D virtual point;
determining a second length between a 2D coordinate of the reference location and a 2D coordinate of the 3D virtual point; and
determining how to update the current view based on the determined first length and the determined second length.

7. The method of claim 6, comprising calculating a second distance value based on the first distance value and a ratio of the first length and the second length.

8. The method of claim 7, wherein the second distance value is calculated based on the first distance value×(the second length/the first length).

9. The method of claim 7, comprising:
calculating a third distance value indicating a distance between the first location and the second location; and
comparing the third distance value and the second distance value, wherein
how to update the current view is determined based on the comparison.

10. The method of claim 9, wherein, in response to determining that the second distance value is less than or equal to the third distance value, determining how to update the current value comprises determining to enlarge a portion of the current view.

11. The method of claim 9, wherein, in response to determining that the second distance value is greater than the third distance value, determining how to update the current value comprises determining to switch from the current view to said another view.

12. The method of claim 1, wherein
the 360-degree view shown in the first image is divided into a plurality of sectors each of which is assigned with a range of angle,
the plurality of sectors includes a first sector assigned with a first range of angle,
the different locations include the second location and a third location,
the second and third locations belong to the first sector,
determining how to update the current view comprises:
identifying from the ranges of angle the first range of angle in which an angle formed by the directional vector is included;
determining that the second and third locations belongs to the first sector; and
selecting from the second and third locations the second location based on a comparison related to the second and third locations.

13. The method of claim 12, wherein the comparison related to the second and third locations is a comparison between a distance value indicating a distance between the first location and the second location and a distance value indicating a distance between the first location and the third location.

14. The method of claim 1, wherein
the first image comprises a plurality of channels,
the plurality of channels includes a depth channel indicating a plurality of depth values each of which is associated with each pixel included in the first image, and
one of the depth values is the first distance value.

15. A non-transitory computer readable storage medium storing a computer program comprising instructions for configuring an apparatus to perform the method of claim 1.

16. (canceled)

17. An apparatus for changing a view within a virtual three-dimensional, (3D) environment generated using a plurality of images each of which shows a 360-degree view of a real environment at different locations within the real environment, wherein the plurality of images includes a first image captured at a first location within the real environment and a second image captured at a second location within the real environment, the apparatus comprising:
obtain a current view of the virtual 3D environment, wherein the current view is with respect to the first location;
obtain an indication of a user's action for changing a view within the virtual 3D environment, wherein the changed view is associated with a directional vector;
identify a 3D virtual point corresponding to the directional vector, wherein the 3D virtual point is associated with a first distance value indicating a distance between the first location and a real physical point corresponding to the 3D virtual point; and
based on the first location, the second location, and the first distance value, determine how to update the current view, wherein updating the current view is either enlarging a portion of the current view or changing to another view that is with respect to the second location.

18. The apparatus of claim 17, wherein
the 360-degree view shown in the first image is divided into a plurality of sectors,
each of the plurality of sectors is assigned a range of angle, and
determining how to update the current view comprises:
identifying from the ranges of angle a first range of angle in which an angle formed by the directional vector is included; and
determining if any of the different locations belongs to the sector assigned with the identified first range of angle.

19. The apparatus of claim 18, wherein determining how to update the current view comprises:
determining that none of the different locations belongs to the sector assigned with the identified first range of angle; and
as a result of determining that none of the different locations belongs to the sector assigned with the identified first range of angle, updating the current view by enlarging a portion of the current view.

20. The apparatus of claim 18, wherein determining how to update the current view comprises:
(i) determining that the second location belongs to the sector assigned with the identified first range of angle;
(ii) determining that a transition condition is satisfied; and
as a result of determining (i) and (ii), updating the current view by changing from the current view to said another view, wherein said another view with respect to the second location.

21. The apparatus of claim 17, comprising:
generating a virtual geometry using the first image, wherein
a center of the virtual geometry is a reference location,
a direction of the directional vector is from the reference location towards a side of the virtual geometry, and
the 3D virtual point is a point on the side of the virtual geometry, which corresponds to an intersection of the directional vector and the virtual geometry.

22-31. (canceled)
